(19) United States
(12) Patent Application Publication
(10) Pub. No.: US 2021/0005189 A1
(43) Pub. Date: Jan. 7, 2021

(54) DIGITAL ASSISTANT DEVICE COMMAND PERFORMANCE BASED ON CATEGORY

(71) Applicant: Lenovo (Singapore) Pte. Ltd., Singapore (SG)

(72) Inventors: Russell Speight VanBlon, Raleigh, NC (US); Mark Patrick Delaney, Raleigh, NC (US); Nathan J. Peterson, Oxford, NC (US); John Carl Mese, Cary, NC (US); Arnold S. Weksler, Raleigh, NC (US)

(21) Appl. No.: 16/460,692

(22) Filed: Jul. 2, 2019

(51) Int. Cl. G10L 15/22; G06F 16/9032; H04M 1/725; H04L 12/28

(52) U.S. Cl. CPC G10L 15/22; H04L 12/282; H04M 1/72522; G06F 16/90332

(57) ABSTRACT

One embodiment provides a method, including: receiving, at an information handling device, a user command; identifying, using a processor, a category associated with the user command; determining, based on the identifying, a digital assistant associated with the category; and performing, responsive to determining that the digital assistant is associated with the information handling device, a function corresponding to the user command using the information handling device. Other aspects are described and claimed.

### BACKGROUND

Information handling devices (“devices”), for example, smart phones, tablet devices, laptop computers, smart speakers, and the like may employ digital assistants (“digital assistants”) that are capable of processing user commands. For example, the digital assistants may be voice-activated and may be configured to detect audible user input. Responsive to recognizing an audible command, the digital assistant may execute a corresponding task.

### BRIEF SUMMARY

In summary, one aspect provides a method, comprising: receiving, at an information handling device, a user command; identifying, using a processor, a category associated with the user command; determining, based on the identifying, a digital assistant associated with the category; and performing, responsive to determining that the digital assistant is associated with the information handling device, a function corresponding to the user command using the information handling device.

Another aspect provides an information handling device, comprising: a display screen; a processor; a memory device that stores instructions executable by the processor to: receive a user command; identify a category associated with the user command; determine, based on the identifying, a digital assistant associated with the category; and perform, responsive to determining that the digital assistant is associated with the information handling device, a function corresponding to the user command using the information handling device.

A further aspect provides a system, comprising: at least two connected information handling devices, each of the at least two connected information handling devices comprising a storage device that stores code, the code being executable by a processor and comprising: code that detects a user command; code that identifies a category associated with the user command; code that determines, based on the identifying, which of the at least two connected information handling devices comprises a digital assistant associated with the category; and code that directs an associated information handling device to perform a function corresponding to the user command.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method of directing a digital assistant device associated with a category to perform a function corresponding to a user command.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Conventionally, digital assistant software employed on devices may identify a vocal command provided by a user, associate that command with a corresponding task, and subsequently take actions to complete the task. For example, a user may command a digital assistant to add one or more items to a shopping list. Upon recognizing the command, the digital assistant may add the requested items to a stored list and thereafter present the stored items to the user when commanded.

Today, many households have multiple digital assistant devices that are capable of performing a variety of functions and that may control various features around the house. In these multi-digital assistant environments, it may be difficult to remember which digital assistant device controls which household feature (e.g., light adjustment, temperature adjustment, etc.) or which digital assistant device is capable of, or should, execute a particular task. For example, a user providing a light activation command to a device may not realize that the device is not responsible for, or is not capable of, light activation tasks. In this situation a user may need to repeat the light activation command to multiple devices until the correct device is identified. As another example, a user may command Device A to add an item to a shopping list only to later find out that Device B contained other items from the shopping list that the user previously added. This type of feature overlap between devices may be frustrating and may cause a bad user experience.

Existing solutions require a user to remember the relevant device that their command applies to. However, such a requirement is burdensome and may be especially onerous if many devices exist that comprise similar function-performing capabilities. Additionally, if a user provides an audible command that is detected by more than one device, multiple digital assistants may attempt to perform a function corresponding to the command, which may negatively affect proper execution of the command and/or may produce unwanted output.

Accordingly, an embodiment may identify a particular device, or digital assistant employed by the device, to perform a function of a user command based upon a category of the user command. In an embodiment, a user command may be received or detected by a device. An embodiment may then identify a category associated with the user command (e.g., media task category, home automation category, time management making category, list-making task category, etc.) and determine whether a digital assistant employed by the device is associated with the category. Responsive to determining that the digital assistant of the device is associated with the category, an embodiment may perform a function corresponding to the user command using the device. However, if an embodiment determines that the digital assistant associated with the category is employed by another device, an embodiment may direct the other digital assistant to perform the task. Such a method may intelligently identify the correct digital assistant/device to perform a function corresponding to a particular user command.

The illustrated example embodiments will be best understood by reference to the figures. The following description is intended only by way of example, and simply illustrates certain example embodiments.

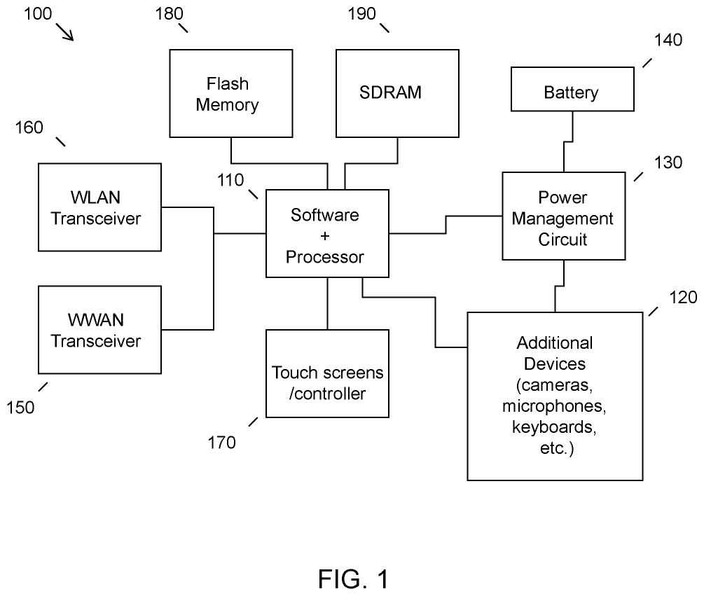

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, devices 120 are commonly included, e.g., an image sensor such as a camera, audio capture device such as a microphone, external keyboard, other input devices, etc. System 100 often includes one or more touch screens 170 for data input and display/rendering. System 100 also typically includes various memory devices, for example flash memory 180 and SDRAM 190.

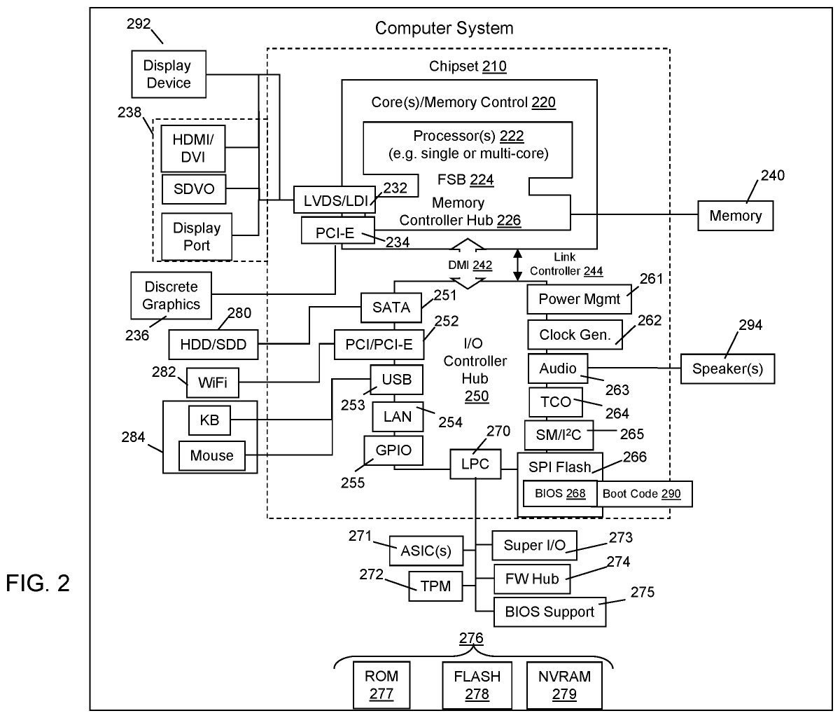

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a low voltage differential signaling (LVDS) interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as smart phones, tablets, smart speakers, dedicated digital assistant devices, and/or other electronic devices that employ digital assistant software and that may be capable of communicating with other devices. For example, the circuitry outlined in FIG. 1 may be implemented in a smart speaker embodiment, whereas the circuitry outlined in FIG. 2 may be implemented in a laptop.

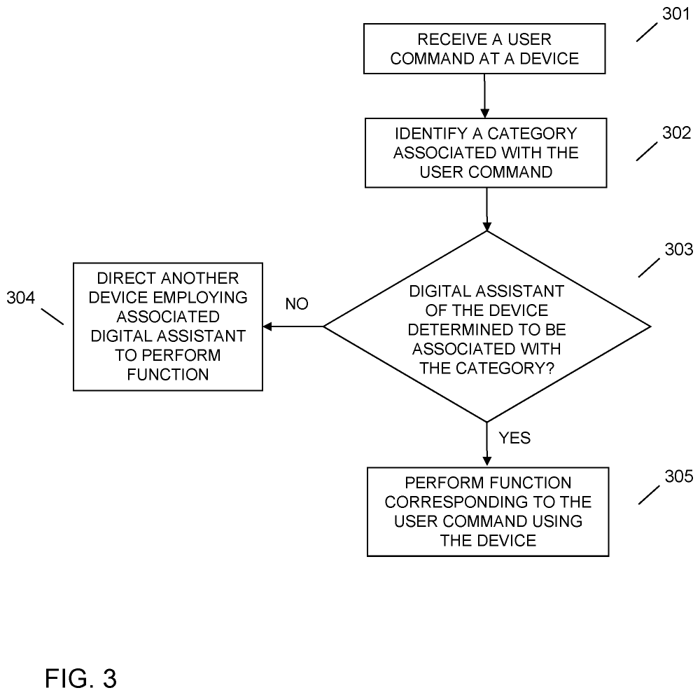

Referring now to FIG. 3, an embodiment may identify a device to perform a function corresponding to a particular user command. At 301, an embodiment may receive or detect a user command at a device. The user command may be virtually any type of conventional input command (e.g., voice command, gesture command, keyboard command, etc.). For simplicity purposes, the remainder of the application will be discussed with reference to user voice commands. However, such a designation is not limiting and other types of user commands, as previously mentioned, may also be utilized to provide the command.

In an embodiment, the user command may be received or detected by one device, or, alternatively, may be received or detected by multiple devices substantially simultaneously. In the case of the latter, the devices may communicate between themselves (e.g., through a wired or wireless connection, etc.) to inform the other devices that a particular user command has been received or detected.

At 302, an embodiment may identify a category associated with the user command. In an embodiment, each category may be associated with a particular task theme. For example, a media task category may correspond to all user commands directing a device to play, stop, pause, etc., different types of media. As another example, a home automation task category may correspond to all user commands affecting a characteristic in a user's home or area (e.g., light activation commands, temperature adjustment commands, door lock commands, etc.). In yet another example, a time management task category may correspond to all user commands that are related to scheduling and/or timeliness (e.g., calendar entry command, reminder command, alarm-setting command, timer command, etc.). In yet another example, a list-making task category may correspond to any user command related to list creation or organization (e.g., shopping list creation, favorite's list creation, notes list creation, etc.). It is important to note that the foregoing category examples are not limiting and other types of categories, not explicitly described here, may also exist.

In an embodiment, the identification of the category may be implemented using one or more techniques. For example, an embodiment may first access a database (e.g., stored locally on the device or remotely on another device or server, etc.) comprising a list of associations between user commands and categories. An embodiment may then compare the user command to commands stored in the list to determine whether there is a match. If a match exists, then the category associated with the matched user command may be identified. In an embodiment, the list of command-category associations may be originally set by a manufacturer but may be later adjusted by a user.

At 303, an embodiment may determine one or more devices, or one or more digital assistants employed on devices, associated with the identified category. More particularly, an embodiment may identify an ecosystem of one or more digital assistants (e.g., employed on a singular device, employed on multiple devices, associated with a singular brand, associated with different brands, etc.) designated to perform functions associated with the identified category. In an embodiment, the determination may be conducted by accessing a database (e.g., stored locally on the device or remotely on another device or server, etc.) comprising a list of associations between devices/digital assistants and categories. An embodiment may then compare the identified category to categories stored in the list to determine whether there is a match to a device or digital assistant. In an embodiment, the list of category-device/digital assistant associations may be originally set by a manufacturer but may be later adjusted by a user.

In an embodiment, if the command-receiving device determines, at 303, that it employs the digital assistant associated with the identified category, then the command-receiving device, or a digital assistant employed by the command-receiving device, may, at 305, perform a function corresponding to the user command. Alternatively, if the command-receiving device determines, at 302, that it does not employ the digital assistant associated with the identified category, the command-receiving device may then, at 304, direct another device identified as employing a digital assistant associated with the identified category to perform a function corresponding to the user command. In an embodiment, the other device may be a device that hasn't detected the user command. As a non-limiting practical example of the foregoing, a user may provide the command “dim the lights”. An embodiment may identify that this command is associated with a home automation category and may further determine that all home automation tasks are to be performed by Digital Assistant A. If Digital Assistant B is the device to receive or detect the command, then Digital Assistant B may pass the user command along to Digital Assistant A for performance.

In an embodiment, the command-receiving device may transmit (e.g., via a wired or wireless connection, etc.) an indication of the user command to the other device employing the digital assistant associated with the identified category. In an embodiment, the direction of the user command to the relevant other device may occur automatically and without any additional user input. More particularly, a user does not need to reiterate the command once they realize the command-receiving device is not associated with the identified category.

In an embodiment, even if a user command comprises an indication for a particular device or digital assistant to perform a function, only the device or digital assistant associated with the category may perform the function. For example, a user may provide the command “ALEXA, add milk to my shopping list”, which may be identified as being associated with a list-making category. Although the wake word in the user command may conventionally be used to address an Amazon ECHO device, a GOOGLE HOME device may the one associated with the list-making category. In such a situation, the GOOGLE HOME may be the one to process the user command and add milk to the shopping list. ALEXA is a registered trademark of Amazon Technologies, Inc. in the United States and other countries. Amazon ECHO is a registered trademark of Amazon Technologies, Inc. in the United States and other countries. GOOGLE HOME is a registered trademark of GOOGLE LLC in the United States and other countries.

In an embodiment, one or more of the digital assistant devices in a connected network may maintain a record of functions performed by other devices in the network. For example, in an embodiment, when one of the digital assistant devices performs a function corresponding to a user command, it may transmit an indication of the performance to one or more other digital assistant devices. In an embodiment, if more than one digital assistant device is associated with a category of the command then the devices may communicate between themselves to determine which device is best suited to perform the command (e.g., the device that is most proximate to the user, the device that most frequently performs the commands associated with the category, etc.).

In an embodiment, if the category of the command cannot be recognized or if no device or digital assistant can be identified as being associated with the category, the device-receiving command may assume responsibility for the performance of the task associated with the command. For example, if the user command “provide me directions to the grocery store” is identified as being associated with a mapping category but no device or digital assistant is determined to be associated with the mapping category, the command-receiving device may be the one to provide the directions if it is capable. In an embodiment, the command-receiving device may then automatically be associated with the mapping category and may thereafter be responsible for performing all direction related functions. In an embodiment, if the command-receiving device is unable to perform a task corresponding to the user command, then it may identify another device that may be able to do so and direct the user command to it.

The various embodiments described herein thus represent a technical improvement to conventional methods for executing a user command using a digital assistant device. Using the techniques described herein, an embodiment may first receive or detect a user command. An embodiment may then identify a category associated with the user command and thereafter determine a digital assistant device associated with the category. If the determined digital assistant device is the command-receiving device then the command-receiving device may perform a function corresponding to the user command. Alternatively, if the determined digital assistant device is not associated with the command-receiving device, then an embodiment may provide an indication to the determined digital assistant device to perform the function. Accordingly, such a method may automatically identify the best digital assistant device to handle user commands.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, a system, apparatus, or device (e.g., an electronic, magnetic, optical, electromagnetic, infrared, or semiconductor system, apparatus, or device) or any suitable combination of the foregoing. More specific examples of a storage device/medium include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
receiving, at an information handling device, a user command;
identifying, using a processor, a category associated with the user command;
determining, based on the identifying, a digital assistant associated with the category; and
performing, responsive to determining that the digital assistant is associated with the information handling device, a function corresponding to the user command using the information handling device.

2. The method of claim 1, wherein the category is associated with a task selected from the group consisting of a media task, a home automation task, a time management task, and a list-making task.

3. The method of claim 1, wherein the identifying comprises accessing a database comprising a list of associations between user commands and categories.

4. The method of claim 1, wherein the determining comprises accessing a database comprising a list of associations between digital assistants and categories.

5. The method of claim 4, wherein the list is adjustable by a user.

6. The method of claim 1, further comprising directing, responsive to determining that the digital assistant is associated with another device, the another device to perform the function.

7. The method of claim 6, wherein the directing comprises automatically directing without receiving additional user input.

8. The method of claim 6, wherein the directing comprises transmitting an indication of the user command to the another device.

9. The method of claim 6, further comprising maintaining, on the information handling device, a record of functions performed by the another device.

10. The method of claim 1, wherein the determining comprises associating the digital assistant with the information handling device responsive to identifying that no other digital assistant of another device is associated with the category.

11. An information handling device, comprising:
a display screen;
a processor;
a memory device that stores instructions executable by the processor to:
receive a user command;
identify a category associated with the user command;
determine, based on the identifying, a digital assistant associated with the category; and
perform, responsive to determining that the digital assistant is associated with the information handling device, a function corresponding to the user command using the information handling device.

12. The information handling device of claim 11, wherein the category is associated with a task selected from the group consisting of a media task, a home automation task, a time management task, and a list-making task.

13. The information handling device of claim 11, wherein the instructions executable by the processor to identify comprise instructions executable by the processor to access a database comprising a list of associations between user commands and categories.

14. The information handling device of claim 11, wherein the instructions executable by the processor to determine comprise instructions executable by the processor to access a database comprising a list of associations between digital assistants and categories.

15. The information handling device of claim 11, wherein the list is adjustable by a user.

16. The information handling device of claim 11, wherein the instructions are further executable by the processor to direct, responsive to determining that the digital assistant is associated with another device, the another device to perform the function.

17. The information handling device of claim 16, wherein the instructions executable by the processor to direct comprise instructions executable by the processor to automatically direct without receiving additional user input.

18. The information handling device of claim 16, wherein the instructions are further executable by the processor to maintain, on the information handling device, a record of functions performed by the another device.

19. The information handling device of claim 11, wherein the instructions executable by the processor to determine comprise instructions executable by the processor to associate the digital assistant with the information handling device responsive to identifying that no other digital assistant of another device is associated with the category.

20. A system, comprising:
at least two connected information handling devices, each of the at least two connected information handling devices comprising a storage device that stores code, the code being executable by a processor and comprising:
code that detects a user command;
code that identifies a category associated with the user command;
code that determines, based on the identifying, which of the at least two connected information handling devices comprises a digital assistant associated with the category; and
code that directs an associated information handling device to perform a function corresponding to the user command.
